(19) United States
(12) Patent Application Publication
(10) Pub. No.: US 2002/0144972 A1
(43) Pub. Date: Oct. 10, 2002

(54) Method for forming rough surface

(75) Inventor: Ching-Yu Chang, I-Lan (TW)

Correspondence Address: LOWE HAUPTMAN GILMAN & BERNER, LLP, Suite 310, 1700 Diagonal Road, Alexandria, VA, 22314, US

(73) Assignee: MACRONIX INTERNATIONAL CO., LTD.

(21) Appl. No.: 09/824,855

(22) Filed: Apr. 4, 2001

(51) Int. Cl. H01G 4/00; H01G 5/00; H01G 7/00; H01G 9/00; H01G 13/00; C23F 1/00; B44C 1/22; C25F 3/00; C03C 15/00; C03C 25/68

(52) U.S. Cl. 216/6; 216/109

(57) ABSTRACT

A method for forming rough surface: first, provide a substrate; then, immerse a surface layer of substrate in a solution which is able to etch surface layer; next, form numerous bubbles in solution such that part of bubbles are located on a surface of surface layer, where surface is contacted with solution; finally, remove solution. The method also could form bubbles in solution before surface layer is immersed in solution, and could perform a dry process after solution is removed. Significantly, this method at least could be used to enhance adhesion of photoresist and increases capacitance of capacitor.

### BACKGROUND OF THE INVENTION

1. Field of the Invention

This invention relates generally to a method for forming a rough surface, particularly related to a method for forming a rough surface on a substrate where materials of the substrate could be etched by at least one solution.

2. Description of the Prior Art

Because current tendencies of electronic products tend to be lighter, thinner, shorter and smaller, critical dimensions of semiconductor devices are continually decreased. As a result, fabrication of semiconductor devices are proportionally increased. Therefore, in order to achieve the following objects: ensure stability of structure of semiconductor devices, ensure correct connection of multi-layer interconnection of semiconductor device, and ensure pattern of mask is properly transformed to photoresist and so on. One important field of fabrication of semiconductor devices is related to the formation of a level surface.

When both structure and fabrication of a semiconductor device is becoming more complex, a rough surface desired for some semiconductor device and corresponding fabrication. For example, capacitance of capacitor is increased by applying of hemispherical silicon (HSG) to increase total surface of electrode of capacitor.

Current available fabrications of semiconductor devices usually can not form a rough surface with low cost and high efficiency. For example, the formation of HSG at least requires both, depositing amorphous silicon and heat treatment, but heat treatment usually induces irnegligible thermal diffusion of the doped region in substrate, therefore HSG can not be formed be formed on any material. For example U.S. Pat. No. 6,169,038 discloses a method for rough-etching a semiconductor surface. This disclosed method is to etch a substrate by using an etching solution on the substrate while this substrate is rotated. The disclosed process is difficult to control and the amount of etching solution used is huge.

In short, conventional fabrication of a semiconductor device can not produce the required rough surface upon any material with both low cost and high efficiency. Thus, it is necessary to develop a new form of fabrication to overcome this problem, in particular, to develop a useful fabrication process for practical production.

### SUMMARY OF THE INVENTION

One main object of the invention is to provide a facile method for forming the required rough surface in the fabrication of semiconductor device.

Another main object of the invention is to provide a simple and cheap method for forming a rough surface in production line.

Another object of the invention is to present a method for enhancing adhesion of photoresist.

Another object of the invention is to present a method for increasing capacitance of capacitor.

Another essential object of the invention is to present a method for planarizing wafer, wherein the method uses both chemical mechanical polishing and wet etching.

Another object of the invention is to present a method for effectively removing all residuals of performed process, such as particles, residual particles and defects, with the advantage of few processing steps.

A further object of the invention is to present a method for repeatedly using a wafer with the advantage of both low cost and high efficiency, especially to present a method for reworking any processing step.

One preferred embodiment of this invention is a method for forming a rough surface. This method at least includes following steps in sequence: provide a substrate, immerse surface layer in solution to remove surface layer from substrate and form numerous bubbles with in solution such that part of bubbles form on surface between surface layer and solution, and remove solution. Thus, because part of surface layer that is covered by bubbles will not be removed, such as etched, by this solution, reaction between surface layer and solution will not uniformly distribute over all the surface, therefore a rough surface is formed. Moreover, the following processes are available: put substrate in a reactor and immerse substrate by solution. Then reduce the pressure of reactor so that bubbles are formed in solution. Place substrate in a reactor and immerse substrate by solution. Then convey a gas into reactor such that bubbles are formed in solution. Put substrate in a reactor and immerse substrate by solution. And last, conveying a gas into said solution such that bubbles are formed in solution.

Another preferred embodiment of this invention is a method for enhancing adhesion of photoresist. Solution with numerous bubbles is used to treat a surface before photoresist is formed, where bubbles form the surface is rough as described in previous embodiment. Significantly, ruggedness of rough surface could enhance physical attraction between photoresist and rough surface, therefore adhesion of photoresist is enhanced.

Further another preferred embodiment of this invention is a method for forming a capacitor. Solution with numerous bubbles is used to treat surface of each dielectric layer, such that the total surface is increased by ruggedness of rough surface. Thus, effect of rough surface is similar to effect of HSG, and then capacitance of capacitor is increased while surface area is increased.

### BRIEF DESCRIPTION OF THE DRAWINGS

A more complete appreciation and many of the attendant advantages thereof will be readily obtained as the same becomes better understood by reference to the following detailed description when considered in connection with the accompanying drawings.

FIG. 1A through FIG. 1C are some cross-sectional illustrations of basic steps of this claimed invention;

FIG. 1D is a possible basic flow-chart of this claimed invention;

FIG. 2A through FIG. 2C are some cross-sectional illustrations of basic steps of one preferred embodiment of this claimed invention;

FIG. 2D is a cross-sectional illustration of relation between photoresist and level surface for conventional technology; and

FIG. 3A through FIG. 3F are some cross-sectional illustrations of basic steps of another preferred embodiment of this claimed invention.

### DESCRIPTION OF THE PREFERRED EMBODIMENT

The preferred embodiments to clearly explain this invention are discussed in detail below. However, it should be emphasized that this claimed invention could be applied to other applications and is not limited by these embodiments. Therefore, the available range of this invention is not limited by present embodiments but is limited by claims.

Wet etching is a mature part of available semiconductor technology, most of the available materials which are used in available semiconductor fabrication has a corresponding solution for etching. Moreover, part of bubbles in solution would cover surface of immersed substrate such that part of surface of substrate which is covered by bubbles would not be removed, or etched, by this solution. Accordingly, the applicant of this invention will provide an important clue to forming a rough surface. First you must immerse substrate in a solution with numerous bubbles so the solution is able to remove (etch) the substrate. Then bubbles on the surface of substrate play the role of photoresist. It is reasonable that action between solution and substrate is not uniformly distributed over the entire surface. Thus, the amount of substrate removed is not uniformly distributed over all surface and then a rough surface is formed. In other words, one important characteristic of this invention is that bubbles are used to play the role of photoresist in conventional fabrication, but bubbles can be located anywhere over the immersed surface of substrate without the usage of a high cost mask.

One preferred embodiment of this invention is a method for forming a rough surface, and at least includes following basic steps:

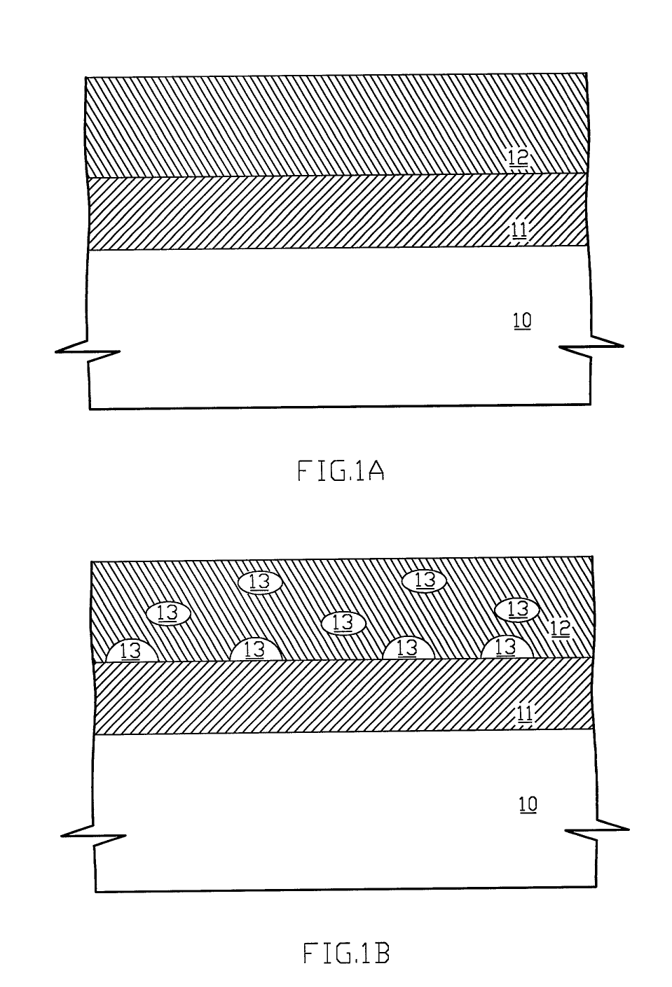

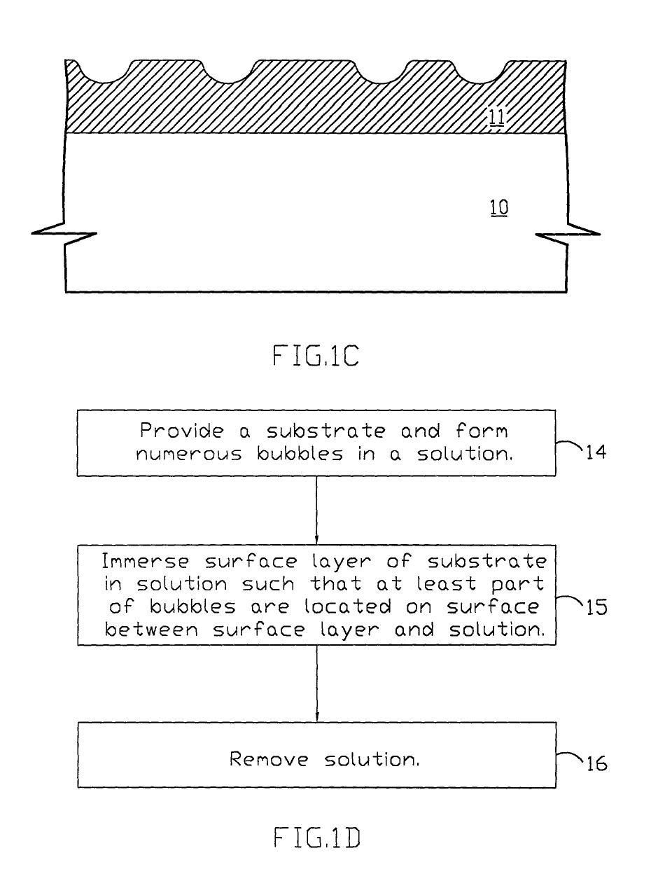

As FIG. 1A shows, provide substrate 10 and immerse surface layer 11 of substrate 10 in solution 12. Wherein solution 12, such as high pressure solution, is able to etch surface layer 11, which means that available varieties of solution 12 is decided by material of surface layer 11. However, this invention is not limited by material of surface layer 11 and material of solution 12. Certainly, immersed period is proportional to decreased thickness of surface layer 11. Besides, this embodiment could further include some semiconductor structures in and on substrate 11, such as transistor, field isolation, well, dielectric layer and isolation layer.

As FIG. 1B shows, form numerous bubbles 13 in solution 12. At least part of bubbles are located on this surface between solution 12 and surface layer 11.

Notice that this invention should not be limited by methods for forming bubbles, this invention also should not be limited by what kind of equipment is used to achieve this invention. For example, it is possible to put substrate 10 in a reactor and immerse substrate 10 by solution 12, especial high-pressure solution, and then reduce pressure in reactor to let bubbles form in solution 12. It is also possible to put substrate 12 in a reactor and immerse substrate 10 in solution 12, and then convey gas into reactor to let bubbles 13 are formed in solution 12. Yet its still possible to put substrate 12 in reactor and immerse substrate 10 in solution 12, and then convey gas into solution 12 to let bubbles 13 form in solution 12. Further its possible to put substrate 12 in reactor and immerse substrate 10 in solution 12 and form bubbles 13 solution 12 by making sure pressure in reactor is lower than pressure of solution 12.

Without doubt, when only part of substrate 10 requires a rough surface, it is reasonable to cover part of surface layer 11, which does not require a rough surface, by photoresist before substrate is immersed in solution 12. Further, whenever several materials exist on surface layer 11 but only part of materials requires rough surface, it could be achieved by using some specific solution which only etch some materials which require rough surface.

As FIG. 1C shows, because part of surface layer 11 which is covered by bubbles 13 would not be removed by solution 12 but bared part of surface layer 11 would be removed by solution 12, rough surface is formed after substrate 10 is immersed in solution during a period. Finally, solution 12 is removed.

Obviously, because the formation of bubbles in solution 12 is a well-known and mature technology, whenever solution for etch material of surface layer 11 is available, this present invention can be used to form rough surface. Moreover, because size and distribution of bubbles 13 can be adjusted by modifying parameters such as temperature and pressure, ruggedness of the formed rough surface can be properly controlled. Therefore, this present method for forming a rough surface not only is a simple and cheap but is also a practical method within a production line.

Besides, the applicant emphasizes the present invention is not limited by whether bubbles 13 are formed after substrate 11 has been immersed in solution 12 or not. In other words, as FIG. 1D shows, another possible flow-chart of this preferred embodiment at least includes the following steps. As providence block 14 shows, provide a substrate and form numerous bubbles in a solution; as immersion block 15 shows, immerse surface layer of substrate in solution such that at least part of bubbles are located on the surface between surface layer and solution; and as end block 16 shows, remove solution.

In additional, dry process, even rinse process, usually is performed after solution 12 is removed to ensure any semiconductor fabrication performed right after is not affected by any residual solution 12. Moreover, available varieties of solution 12 is chosen from a group consisting of: hydrofluoric acid, nitric acid, mixture of hydrofluoric acid and nitric acid, hydrogen peroxide, ammonium fluoride, mixture of hydrogen peroxide and hydrofluric acid, and mixture of ammonium fluoride and hydrofluoric acid. Available varieties of surface layer 11 is chosen from a group of: oxide layer, silicon layer, polysilicon layer, tungsten layer, tungsten silicide layer, titanium layer, titanium silicide layer, copper layer, photoresist, silicon nitride layer, and spin on glass.

To solidly explain the possible application of this invention, another preferred embodiment is a method for enhancing adhesion of photoresist. This embodiment at least includes following basic steps:

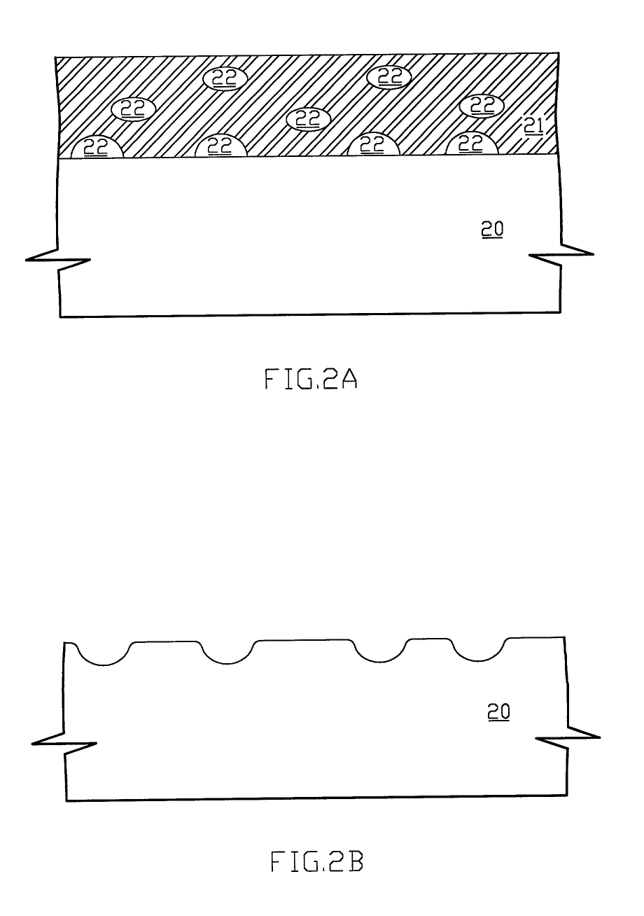

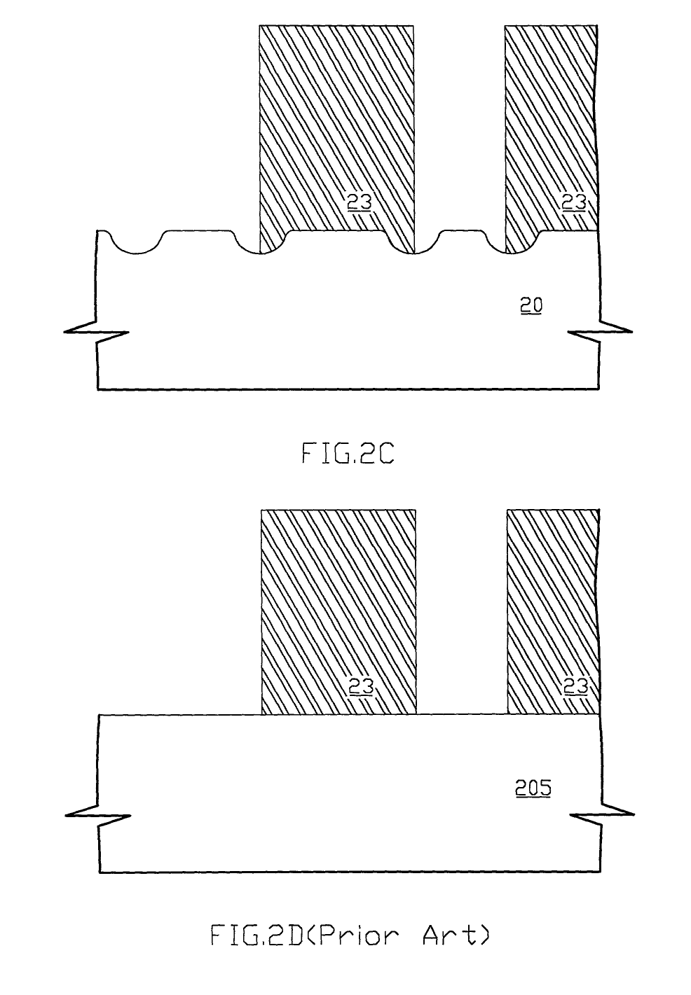

Provide substrate 20 and treat substrate 20 by solution 21 which includes numerous bubbles 22, wherein at least part of bubbles are located on a surface of substrate 20 which is contacted with solution 21. Moreover, as FIG. 2A and FIG. 2B shows, substrate is usually immersed in solution 21 during a period before substrate 20 is removed from solution 21.

As FIG. 2C shows, photoresist 23 forms on this surface. Obviously, physical attraction, (or called as mechanical attraction), between rough surface and photoresist is stronger than the physical attraction between photoresist 23 and substrate 205 with a level surface, as shown in FIG. 2D. Please compare interface between photoresist 23 and substrate 20 of FIG. 2C to the interface between photoresist 23 and substrate 205 of FIG. 2D. Significantly, a rough surface could enhance adhesion of photoresist 23.

Of course, as discussed above, multiple methods could be used to form numerous bubbles in solution 21 and this embodiment is not limited by which method is preformed. Besides, to avoid adhesion of photoresist 23 when affected by residual solution 21 (or part components of residual solution 21), the embodiment could further perform a dry process after substrate 20 and solution 21 are separated and before photoresist 23 is formed.

Another concrete preferred embodiment of this invention is a method for forming a capacitor. This embodiment at least includes the following basic steps:

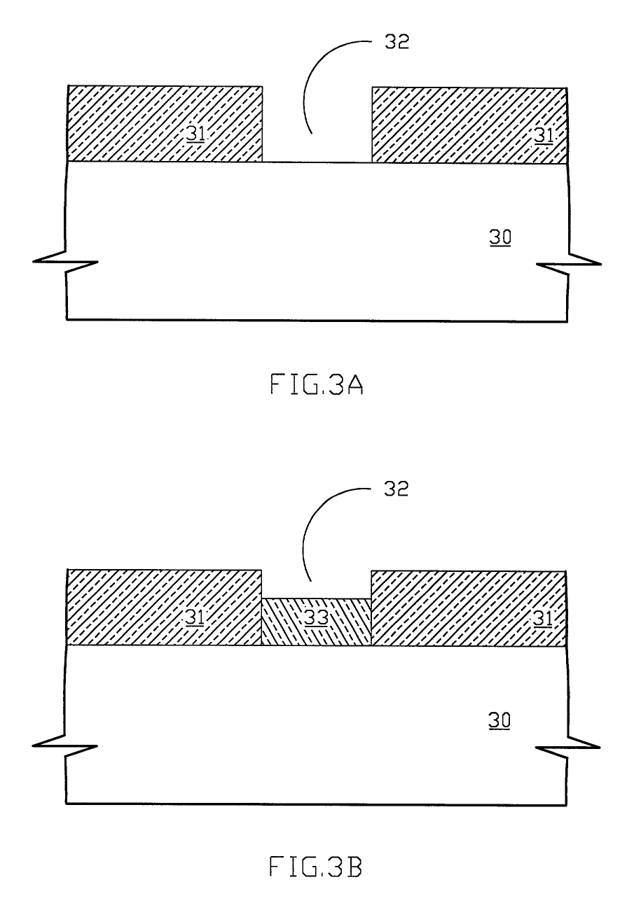

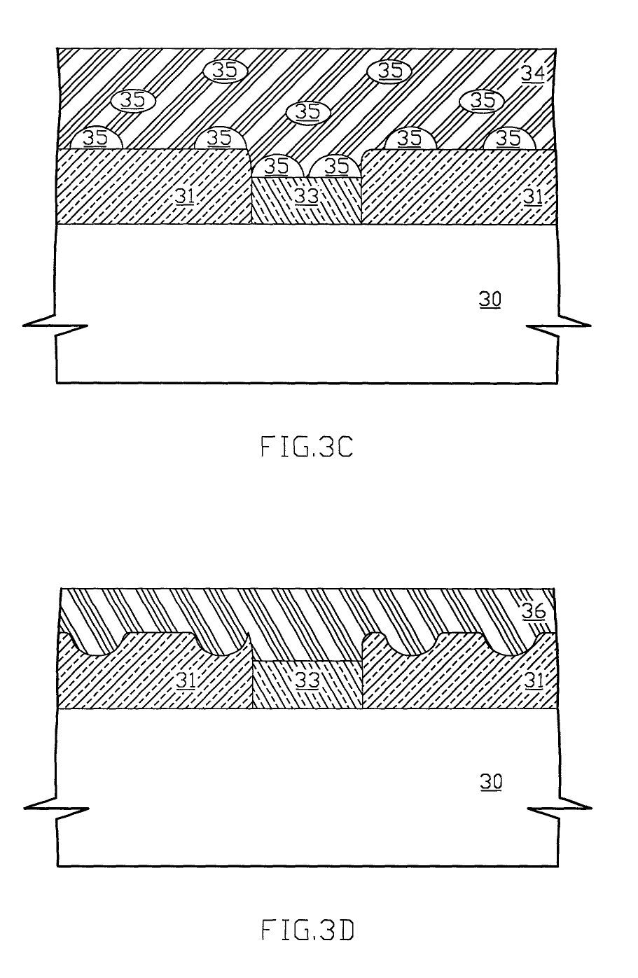

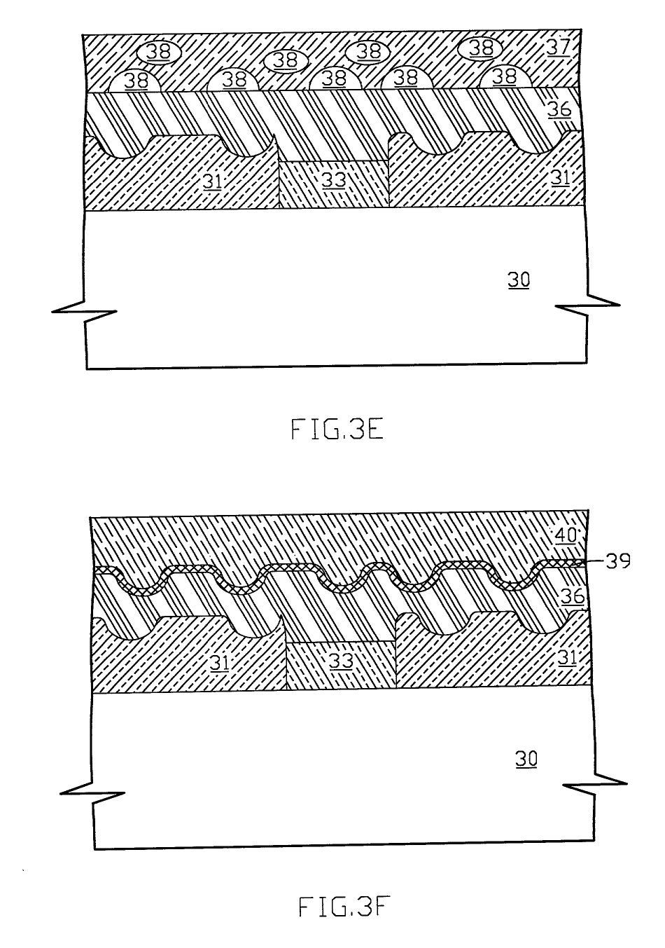

As FIG. 3A shows, provide substrate 30 and form the first dielectric layer 31 on substrate 30, then form hole 32 in first dielectric layer 31 such that part of substrate 30 is exposed.

As FIG. 3B shows, form first conductor layer 33 in hole 32.

As FIG. 3C shows, immerse substrate 30 in first solution 34 with numerous first bubbles 35, where at least part of first bubbles are located on the first surface between first dielectric layer 31 and first solution 34. Herein, existence of first bubbles 35 would allow action between first solution 34 and first dielectric layer 31, but its not uniformly distributed over the entire first surface. Thus, after first dielectric layer 31 is immersed for a predetermined period, the surface of first dielectric layer would be changed from a smooth surface shown in FIG. 3C to a rough surface.

As FIG. 3D shows, remove first solution 34 so that substrate 30 and first solution 34 are separate, then form second conductor layer 36 on both the first dielectric layer 33 and first conductor layer 33.

As FIG. 3E shows, immerse substrate 30 in second solution 37 with numerous second bubbles 38, where at least part of second bubbles are located on a second surface between second conductor layer 36 and second solution 37. Herein, existence of second bubbles 38 would let action between second solution 37 and second conductor layer 36 is not uniformly distributed over the entire second surface. Thus, after second conductor layer 36 is immersed during a predetermined period, surface of second conductor layer 36 would be changed from a smooth surface shown in FIG. 3C to a rough surface.

As FIG. 3F shows, remove second solution 37 so that second solution 37 and substrate 30 are separated and then form second dielectric layer 39 on second conductor layer 36.

Obviously, whenever material of second conductor layer 36 is not equal to material of first dielectric layer, second solution 37 is different to first solution 34. Moreover, both first conductor layer 33, second conductor layer 36 and third conductor layer 40 usually are polysilicon layer.

However, notice that although the previous basic steps are used to rough up both surface of first dielectric layer 31 and surface of second conductor layer, then surface area of electrode of capacitor is increased to increased capacitance of capacitor. This embodiment also could be modified to increased surface area of electrode by roughing surface of first conductor layer 33. Certainly, solution used in this modified case must be able to etch first conductor layer 33, but the idea of using bubbles to form rough surface is not modified.

From the beginning it will be appreciated that although specific embodiments of the invention have been described herein for purposes of illustration, various modifications may be made without deviating from the spirit and scope of said invention. Accordingly, the invention is not limited except as by the appended claims.

What is claimed is:

1. A method for forming rough surface, comprising:
providing a substrate;
immersing a surface layer of said substrate in a solution, said solution being able to remove said surface layer;
forming a plurality of bubbles in said solution, wherein part of said bubbles are located on a surface of said surface layer, said surface being contacted with said solution; and
removing said solution.

2. The method of claim 1, further comprises putting said substrate in a reactor and immersing said substrate by said solution, and then reducing the pressure of said reactor such that said bubbles are formed in said solution.

3. The method of claim 1, further comprises putting said substrate in a reactor and immersing said substrate by said solution, and then conveying a gas into said reactor such that said bubbles are formed in said solution.

4. The method of claim 1, further comprises putting said substrate in a reactor and immersing said substrate by said high pressure solution, and then keep normal pressure of said reactor such that said bubbles are formed in said solution.

5. The method of claim 1, further comprising a plurality of semiconductor structures in and on said substrate.

6. The method of claim 5, wherein said semiconductor structures are chosen from a group consisting of: transistor, field isolation, well, dielectric layer and isolation layer.

7. The method of claim 1, further comprising cover part of said surface by a photoresist before said substrate being immersed in said solution.

8. The method of claim 1, further comprising perform a dry process after said solution being removed.

9. The method of claim 1, wherein said solution is chosen from a group consisting of: hydrofluoric acid, nitric acid, mixture of hydrofluoric acid and nitric acid, hydrogen peroxide, ammonium fluoride, mixture of hydrogen peroxide and hydrofluoric acid, and mixture of ammonium fluoride and hydrofluoric acid.

10. The method of claim 1, wherein said surface layer is chosen from a group of: oxide layer, silicon layer, polysilicon layer, tungsten layer, tungsten silicide layer, titanium layer, titanium silicide layer, copper layer, photoresist, silicon nitride layer, and spin on glass.

11. A method for enhancing adhesion of photoresist, comprising:
providing a substrate;
treating said substrate by a solution with a plurality of bubbles, wherein part of said bubbles are located on a surface of said substrate, said solution being able to remove said substrate and said surface being contacted with said solution; and
forming a photoresist on said surface.

12. The method of claim 11, further comprises putting said substrate in a reactor and immersing said substrate by said solution, and then reducing the pressure of said reactor such that said bubbles are formed in said solution.

13. The method of claim 11, further comprises putting said substrate in a reactor and immersing said substrate by said solution, and then conveying a gas into said reactor such that said bubbles are formed in said solution.

14. The method of claim 11, further comprises putting said substrate in a reactor and immersing said substrate by said high pressure solution, and then keeping the normal pressure of said reactor such that said bubbles are formed in said solution.

15. The method of claim 11, further comprises performing a dry process after said substrate being treated by said solution and before said photoresist being formed.

16. The method of claim 11, wherein said solution is chosen from a group consisting of: hydrofluoric acid, nitric acid, mixture of hydrofluoric acid and nitric acid, hydrogen peroxide, ammonium fluoride, mixture of hydrogen peroxide and hydrofluoric acid, and mixture of ammonium fluoride and hydrofluoric acid.

17. A method for forming capacitor, comprising:
providing a substrate;
forming a first dielectric layer on said substrate;
forming a hole in said first dielectric layer such that part of said substrate is exposed;
forming a first conductor layer in said hole;
immersing said substrate in a first solution which comprises a plurality of first bubbles, wherein said first solution being able to remove said first dielectric layer and part of said first bubbles are located on a first surface of first dielectric layer, said first surface being contacted with said first solution;
removing said first solution;
forming a second conductor layer on both said first dielectric layer and said first conductor layer;
immersing said substrate in a second solution which comprises a plurality of second bubbles, wherein said second solution being able to remove said second conductor layer and part of said second bubbles are located on a second surface of second conductor layer, said second surface being contacted with said second solution;
removing said second solution; and
forming a second dielectric layer and a third conductor layer on said second conductor layer.

18. The method of claim 17, wherein both said first conductor layer and said second conductor layer and said third conductor layer are polysilicon layers.

19. A method for forming rough surface, comprising:
providing a substrate;
forming a plurality of bubbles in a solution, said solution being able to remove said surface layer;
immersing a surface layer of said substrate in said solution, wherein part of said bubbles are located on a surface of said surface layer, said surface being contacted with said solution; and
removing said solution.
